(19) United States
(12) Patent Application Publication
(10) Pub. No.: US 2011/0308450 A1
(43) Pub. Date: Dec. 22, 2011

(54) SPRAYING DEVICE

(75) Inventors: CHIN-TA CHEN, Taiwan (CN); Lungchen Chen, Taiwan (CN); Kuo-Chen Lee, Taiwan (CN); Hsiang Neng Yang, Taiwan (CN)

(73) Assignee: E.I. DU PONT DE NEMOURS AND COMPANY, Wilmington, DE (US)

(21) Appl. No.: 12/968,513

(22) Filed: Dec. 15, 2010

Related U.S. Application Data
(60) Provisional application No. 61/287,541, filed on Dec. 17, 2009.

(30) Foreign Application Priority Data
Sep. 28, 2010 (CN) 20100502923.9
Sep. 28, 2010 (TW) 099132890

(51) Int. Cl. B05B 7/00; B05C 11/02

(52) U.S. Cl. 118/118; 118/300; 118/315

(57) ABSTRACT

A spraying device to be used in an image transfer process is provided, which includes at least one nozzle. A fluid is supplied to each nozzle, and the nozzles spray the fluid on a substrate to form a liquid film. Further, a dual fluid spraying device is also provided. A dual fluid formed by mixing a liquid with a gas is sprayed on a substrate through at least one nozzle of the spraying device, so as to form a thinner and more uniform liquid film. A photoresist can be laminated to a substrate having the liquid film applied to it with the spraying device to afford enhanced conformability of the photoresist in the substrate in the resulting laminate. This enhanced conformability affords reduced defectivity levels in subsequent processing steps during PCB (printed circuit board) manufacture.

### CROSS REFERENCE TO RELATED APPLICATIONS

The present application claims the benefit to priority of U.S. Provisional application No. 61/287,541 filed Dec. 17, 2009, Taiwan patent application number 099132890 filed Sep. 28, 2010, and Chinese patent application number 20100502923.9 filed Sep. 28, 2010.

### BACKGROUND OF THE INVENTION

1. Field of the Invention

The present invention relates to a spraying device, and more particularly to a spraying device to be used in an image transfer process for spraying a liquid film on a substrate to enhance conformability between the substrate and a dry film photoresist subsequently laminated thereon.

2. Description of the Prior Art

A printed circuit board (PCB) is formed by drawing electric wirings that connect circuit components into a wiring pattern according to a circuit design and then reproducing electric conductors on an insulator in machining and surface treatment manners designated in the design. In other words, the PCB is a substrate before electronic components are arranged thereon. Such products enable all the electronic components to fulfill their functions through an electronic circuit formed on the circuit board, so as to achieve the purpose of signal processing. The quality of the PCB design not only directly influences the reliability of electronic products, but also has a certain impact on the overall performance and competitiveness of system products. A copper clad laminate (CCL), a critical basic material for fabricating the PCB, is a laminate stacked of insulation paper, glass cloth, or prepregs of other fiber materials impregnated with resin and covered with a copper foil on one side or both sides under high temperature and high pressure. In the fabrication process of the circuit board, precise wirings are fabricated through techniques such as printing, photographing, etching, and electroplating to function as an assembly base supporting interconnections of electronic components and circuits between the components. Therefore, the technology of forming high-density and multi-layered wirings becomes mainstream in the development of PCB fabrication industry.

A method of fabricating a wiring pattern on a PCB is briefly explained in the following. First, a CCL is cut into a size suitable for processing and manufacturing. Then, a proper coarsening process is usually performed first on the copper foil on the substrate through brush graining or micro-etching in preparation for diaphragm molding. Next, a dry film photoresist is firmly attached to the substrate under suitable temperature and pressure in a rolling manner. Later, the CCL with the dry film photoresist attached is sent into an ultraviolet exposing machine to be exposed. Polymerization occurs to the photoresist when a light transmissive area of a negative is irradiated by ultraviolet rays (the dry film of this area is kept in the subsequent developing and copper etching processes to serve as an etching resist), and a wiring image on the negative is transferred to the dry film photoresist on the board. After a protective film is removed from the film surface, the regions on the film surface that are not irradiated are first developed and removed with a Na₂CO₃ solvent. The exposed copper foil is then eroded and removed with an HCl/H₂O₂ mixed solvent, so as to form the desired wiring pattern.

The dry film photoresist is an important photosensitive material applied in an image transfer process of PCB wirings, and is capable of explicitly reflecting the designed precise wirings on a circuit board so as to produce a substrate having a high-density, light, thin, and multi-layered structure. However, in the process of rolling the dry film photoresist, the dry film photoresist may fail to be firmly attached on the substrate due to factors like foreign dust or minor gaps produced in the rolling process. This problem may affect the precision of the subsequent image transfer process, thus decreasing the yield of PCB fabrication.

### SUMMARY OF THE INVENTION

In order to solve the above problem, the present invention is directed to a spraying device applied in an image transfer process. The spraying device sprays liquid on a substrate to form a liquid film, so as to enhance conformability between the substrate and a dry film photoresist subsequently laminated thereon, thereby improving the precision of the image transfer process.

The present invention provides a single-fluid spraying device. The spraying device is applied in an image transfer process and includes at least one nozzle. A fluid is supplied to each nozzle, and the nozzles spray the fluid on a substrate to form a liquid film.

In an embodiment of the present invention, the nozzles include a plurality of first nozzles and a plurality of second nozzles configured opposite the first nozzles. A distance exists between the first nozzles and the second nozzles, so as to enable the substrate to pass between the first nozzles and the second nozzles.

In an embodiment of the present invention, the distance between the first nozzles and the substrate is substantially equal to the distance between the second nozzles and the substrate.

In an embodiment of the present invention, the distance between each of the first nozzles and the substrate and the distance between each of the second nozzles and the substrate are in the range of 10 mm to 200 mm.

In an embodiment of the present invention, the spraying device further includes an auxiliary roller, disposed on a side of the (first and/or second) nozzles where the substrate passes between the plurality of first nozzles and the plurality of second nozzles and suitable for guiding the substrate to pass between the nozzles.

In an embodiment of the present invention, the spraying device further includes a liquid containing roller unit disposed on another side (an opposing side) of the (first and/or second) nozzles where the substrate passes away from the nozzles.

In an embodiment of the present invention, the liquid film is a water film.

In an embodiment of the present invention, the average particle size of the liquid ejected by each nozzle is in the range of 100 μm to 400 μm.

In an embodiment of the present invention, the temperature of the liquid ejected by each nozzle is approximately in the range of is in a range of 22° C. to 60° C.

In an embodiment of the present invention, the pressure for driving the fluid into each nozzle is approximately in the range of 1 kg/cm² to 5 kg/cm².

In an embodiment of the present invention, the pressure for driving the fluid into each nozzle is preferably around 2 kg/cm².

The present invention further provides a dual fluid spraying device. The spraying device is applied in an image transfer process and includes at least one spraying unit. Each spraying unit includes a first inlet pipe, a second inlet pipe, and a nozzle connected to the first inlet pipe and the second inlet pipe. A liquid and a gas are guided in the first inlet pipe and the second inlet pipe respectively and then are mixed to form a plurality of foggy droplets to be ejected by the nozzle, so as to spray the liquid to form a film of the liquid on the substrate prior to lamination of a photoresist onto the substrate.

In an embodiment of the present invention, the nozzle(s) include a plurality of first nozzles and a plurality of second nozzles configured opposite the first nozzles. A distance exists between the first nozzles and the second nozzles, so as to enable the substrate to pass between the first nozzles and the second nozzles.

In an embodiment of the present invention, the distance between the first nozzles and the substrate is substantially equal to the distance between the second nozzles and the substrate.

In an embodiment of the present invention, the distance between each of the first nozzles and the substrate and the distance between each of the second nozzles and the substrate are in the range of 10 mm to 200 mm.

In an embodiment of the present invention, the spraying device further includes an auxiliary roller, disposed on a side of the (first and/or second) nozzles where the substrate passes between the plurality of first nozzles and the plurality of second nozzles and suitable for guiding the substrate to pass between the nozzles.

In an embodiment of the present invention, the spraying device further includes a liquid containing roller unit disposed on another side (an opposing side) of the (first and/or second) nozzles where the substrate passes away from the nozzles.

In an embodiment of the present invention, the liquid film is a water film. In an embodiment of the present invention, the average particle size of the liquid ejected by each nozzle is in a range of 20 μm to 100 μm.

In an embodiment of the present invention, the temperature of the liquid ejected by each nozzle is approximately in the range of room temperature to 60° C.

In an embodiment of the present invention, the liquid is driven into the first inlet pipe of each nozzle in a siphon manner.

In an embodiment of the present invention, the liquid is driven into the first inlet pipe of each nozzle in a hydraulic manner.

In an embodiment of the present invention, the pressure for driving the liquid into the first inlet pipe of each nozzle in the hydraulic manner is approximately in the range of 1 kg/cm² to 5 kg/cm².

In an embodiment of the present invention, the pressure for driving the gas into the second inlet pipe of each nozzle is approximately in the range of 0.1 kg/cm² to 5 kg/cm².

In the present invention, the spraying device is mainly applied in an image transfer process. The spraying device sprays liquid on a surface of a substrate to form a liquid film to enhance conformability between the substrate and a dry film photoresist subsequently laminated thereon, thereby avoiding decreased yield of the substrate due to poor attachment between the substrate and the dry film.

In addition to the spraying of a single fluid, the present invention also provides the spraying of a dual fluid formed by mixing a liquid and a gas, so as to form a thinner and more uniform liquid film on the substrate, thereby achieving firmer attachment between the substrate and the dry film.

### BRIEF DESCRIPTION OF THE DRAWINGS

FIG. 1 is a schematic three-dimensional view of a spraying device according to a first embodiment of the present invention;

FIGS. 2A and 2B are schematic three-dimensional views of the spraying device in FIG. 1 after an auxiliary roller and a liquid containing roller unit are added to different sides thereof; and

FIG. 3 is a schematic three-dimensional view of a spraying device according to a second embodiment of the present invention.

### DETAILED DESCRIPTION

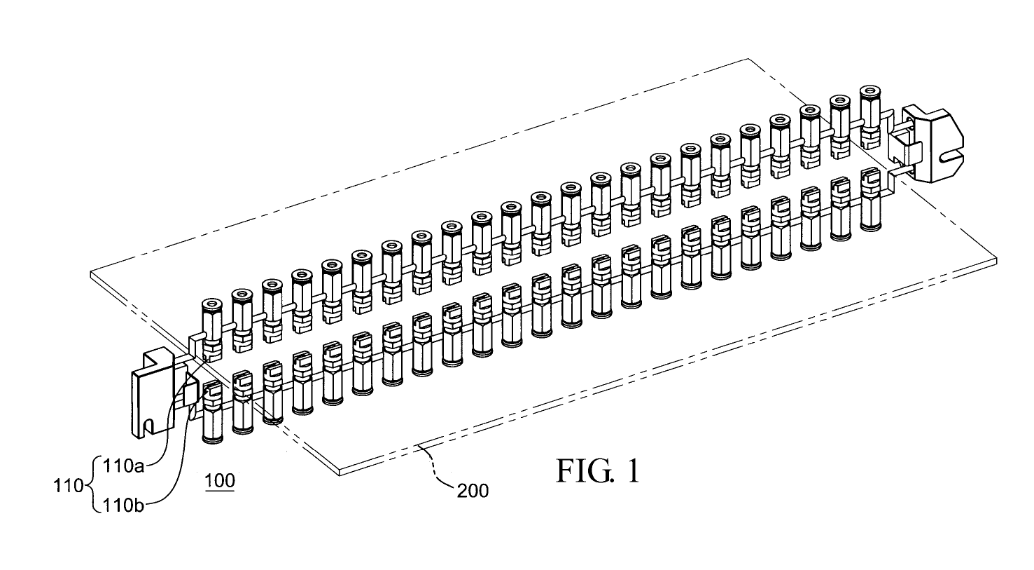

FIG. 1 is a schematic three-dimensional view of a spraying device according to a first embodiment of the present invention. The spraying device 100 is applied in an image transfer process (for example, an image transfer process of a PCB) for providing spraying of a fluid. In actual applications, a substrate (such as a CCL) or a glass substrate) 200 passes through the spraying device 100 and a liquid film is sprayed on a surface of the substrate 200 with the spraying device 100, so as to enhance conformability between the substrate 200 and a dry film photoresist subsequently laminated thereon (not shown).

As shown in FIG. 1, the spraying device 100 includes at least one nozzle 110 for performing a spraying procedure on the substrate 200. In this embodiment, the nozzles 110 include a plurality of first nozzles 110a and a plurality of second nozzles 110b arranged in an upper row and a lower row. The second nozzles 110b and the first nozzles 110a are configured opposite each other, so as to perform the spraying procedure on the top and bottom surfaces of the substrate 200 at the same time. However, only one row of nozzles may also be arranged in accordance with users' demands, so as to perform the spraying procedure on one surface of the substrate. The present invention does not limit the number or arrangement of the nozzles.

As shown in FIG. 1, a distance exists between the first nozzles 110a and the second nozzles 110b, so as to enable the substrate 200 to pass between the first nozzles 110a and the second nozzles 110b. Basically, the distance between the first nozzles 110a and the substrate 200 is substantially equal to the distance between the second nozzles 110b and the substrate 200. Furthermore, the distance between each of the first nozzles 110a and the substrate 200 and the distance between each of the second nozzles 110b and the substrate 200 are in the range of 10 mm to 200 mm, so as to achieve a desired spraying effect.

In practice, a fluid (for example, water) is supplied in each nozzle 110, and a liquid film (for example, a water film) is sprayed on a surface of the substrate 200 through the nozzles 110. In this manner, when a dry film is laminated on the substrate subsequently, conformability between the substrate 200 and the dry film is enhanced by the liquid film, so as to avoid deteriorated precision of the image transfer process due to poor attachment of the dry film.

Generally, the fluid supplied in each nozzle 110 is water or other fluids, and the present invention does not limit it. In an embodiment of the present invention, a preferred temperature of the liquid ejected by each nozzle 110 is about 60° C. In addition, the average particle size of the liquid ejected by each nozzle 110 is in the range of 100 μm to 400 μm. In an embodiment of the present invention, the pressure for driving the fluid into each nozzle 110 is approximately in the range of 1 kg/cm² to 5 kg/cm². Furthermore, the pressure for driving the fluid into each nozzle 110 is preferably around 2 kg/cm². The above operating conditions are preferred operating parameters. However, the present invention is not limited to the above operating conditions.

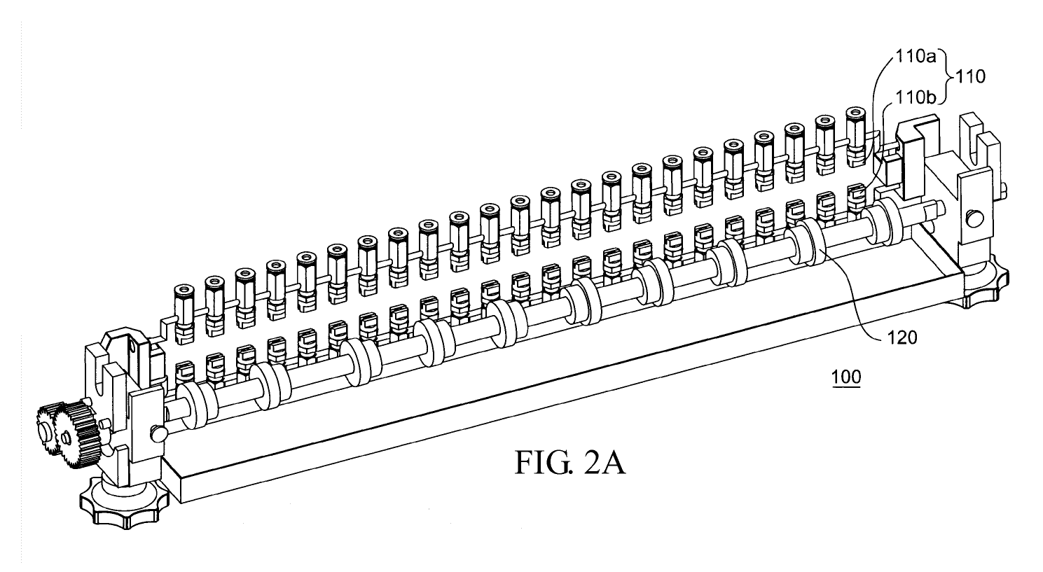

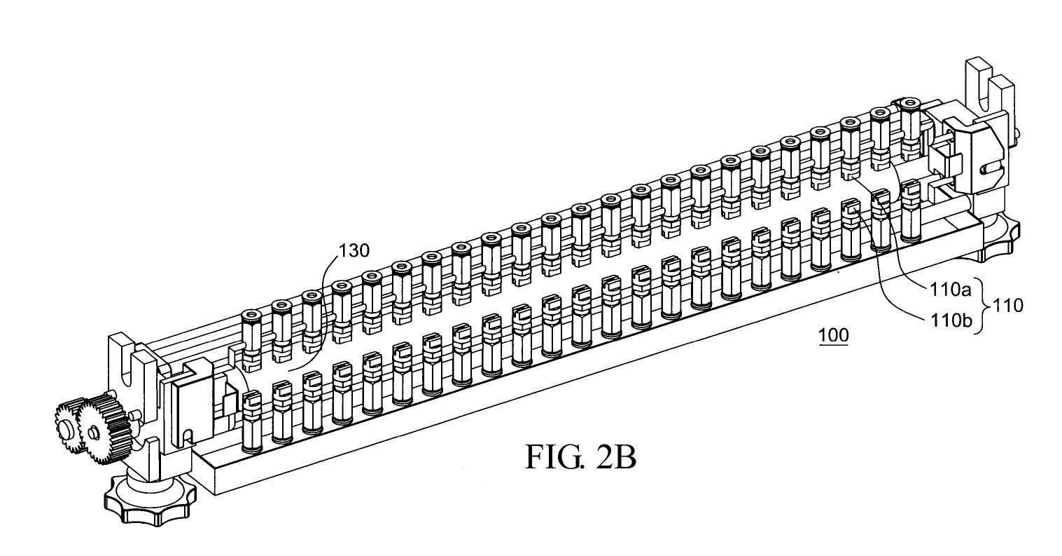

FIGS. 2A and 2B are schematic three-dimensional views of the spraying device in FIG. 1 after an auxiliary roller and a liquid containing roller unit, respectively, are added. In an embodiment of the present invention, as shown in FIG. 2A, for the spraying device 100, an auxiliary roller 120 is disposed on a side of the nozzles 110. The substrate 200 first passes the auxiliary roller 120 and then passes between the nozzles 110 with the guidance of the auxiliary roller 120.

In another embodiment of the present invention, as shown in FIG. 2B, for the spraying device 100, a liquid containing roller unit 130 is disposed on an other side of the nozzles 110 and a liquid (for example, water) is coated on a surface of the liquid containing roller unit 130. The substrate 200 first passes between the nozzles 110, so as to form a liquid film on a top and a bottom surface of the substrate 200. Next, the substrate 200 passes the liquid containing roller unit 130, so as to ensure that a liquid film is completely coated on the surfaces of the substrate 200. (The liquid containing roller unit 130 is moistened by a liquid (e.g., water) from either the spraying device or the liquid coated substrate.)

Either or both of the auxiliary roller 120 (see FIG. 2A) and the liquid containing roller unit 130 (see FIG. 2B) may be present in the spraying device 100 in accordance with users' demands. The present invention does not prescribe whether the auxiliary roller 120 and/or the liquid containing roller unit 130 is disposed.

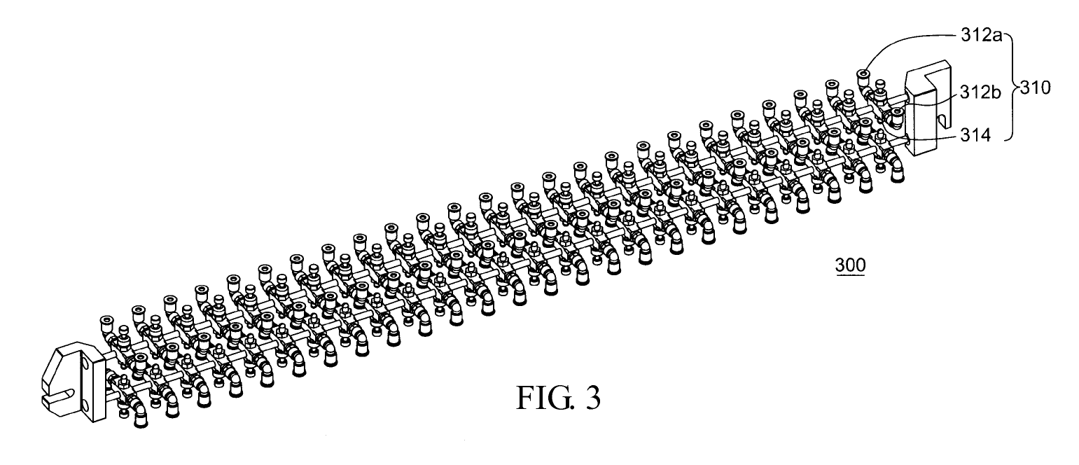

FIG. 3 is a schematic three-dimensional view of a spraying device according to a second embodiment of the present invention. As shown in FIG. 3, the spraying device 300 is applicable to dual-fluid spraying and includes at least one spraying unit 310. Each spraying unit 310 includes a first inlet pipe 312a, a second inlet pipe 312b, and a nozzle 314 connected to the first inlet pipe 312a and the second inlet pipe 312b. A liquid (for example, water) and a gas (for example, air) are guided in the first inlet pipe 312a and the second inlet pipe 312b, respectively, and then mixed into a plurality of foggy droplets to be ejected by the nozzle 314, so as to spray a liquid film (for example, a water film) on a substrate (not shown). As the liquid and gas are mixed into foggy droplets having smaller particle sizes, the liquid film formed is more uniform and much thinner, thereby enhancing attachment between the substrate and the dry film subsequently laminated thereon.

In an embodiment of the present invention, a preferred temperature of the liquid ejected by each nozzle 314 is about 60° C. In addition, the average particle size of the liquid ejected by each nozzle 314 is in the range of 20 μm to 100 μm. The liquid may be driven into the first inlet pipe 312a of each nozzle 314 in a siphon or hydraulic manner. When the liquid is driven into the first inlet pipe 312a of each nozzle 314 in the hydraulic manner, the pressure for driving the liquid into the first inlet pipe 312a of each nozzle 314 is approximately in the range of 1 kg/cm² to 5 kg/cm². In an embodiment of the present invention, the pressure for driving the gas into the second inlet pipe 312b of each nozzle 314 is approximately in the range of 0.1 kg/cm² to 5 kg/cm². The above operating conditions are preferred operating parameters. However, the present invention is not limited to the above operating conditions.

As the detailed structure configurations, operating parameters, and auxiliary mechanisms that can be used in combination (for example, the auxiliary roller 120 as shown in FIG. 2A) of the spraying device 300 are the same as those of the spraying device 100 in FIG. 1, the details are not repeated herein.

Moreover, in the present invention, the spraying of mixed multiple fluids may be realized by disposing a plurality of inlet pipes at each nozzle. This technical concept does not depart from the above embodiments, and the details thereof are not repeated herein.

In sum, the spraying device of the present invention is mainly applied in an image transfer process. The spraying device sprays a liquid film on a surface of a substrate to enhance conformability between the substrate and a dry film photoresist subsequently laminated thereon, thereby avoiding decreased yield of the substrate due to poor attachment between the substrate and the dry film.

In the spraying device of the present invention, in addition to the spraying of a single fluid (for example, water), the present invention may also mix a gas and a liquid to form foggy droplets and then spray the droplets on the substrate to obtain a more uniform and thinner liquid film, thereby achieving a more desirable conformation effect.

The advantages of the invention will be more clearly understood by reference to the following examples.

### Example 1

In this example, a dual-fluid spraying device according to the invention and a conventional wet-lamination device were compared with regard to lamination performance to see how well photoresist being laminated to a substrate conforms to the substrate when the bump height of the substrate is varied. The conventional wet lamination device used in this example was a YieldMaster Wet-lam Kit (E. I. DuPont de Nemours and Company, Wilmington, Del.) that had been integrated into a conventional dry film laminator. The conventional wet-lamination device (Wet-lam Kit) uses a pair of sponge rolls to apply a layer of water onto the surface of the substrate (e.g., copper clad) by contacting the substrate. The dual-fluid spraying device of the present invention worked as stated above. The pressure for driving the gas into the second inlet pipe 312b of each nozzle 314 was 2 kg/cm² in this example and the water was driven into the first inlet pipe 312a of each nozzle 314 under the gravity supply mode of 40 cm height.

In this example, the substrates to be processed have bumps on their surfaces.

The heights of the bumps were 4 μm, 7 μm and 14 μm, respectively. The feed speed of the substrate was 1.5 meters/minute. Riston® FX930 photoresist (E.I. du Pont de Nemours and Company, Wilmington, Del.) was used for lamination. After coating of the water, the substrate was laminated with the dry film photoresist so as to see the conformability between the substrate and the photoresist.

After testing, it was found that both of the conventional wet-lamination device and the dual-fluid spraying device performed well on the substrates with bump height: 4 μm and 7 μm. It was found that the photoresist can be firmly attached to the substrates with 4 μm and 7 μm bump heights after the substrates were coated with water films by either the conventional wet-lamination device or the dual-fluid spraying device of the invention.

However, the photoresist can not be firmly attached to the substrate with 14 μm bump height after the substrate was coated with water films by the conventional wet-lamination device. In sharp contrast, the photoresist can still be firmly attached to the substrate with 14 μm bump height after the substrate was coated with water films by the dual-fluid spraying device of the invention.

### Example 2

In this example, a dual-fluid spraying device according to the invention, a conventional dry-lamination device and a conventional wet-lamination device were compared to determine defect levels using these three lamination devices for lamination and with subsequent exposure, development and etching steps performed on the laminate samples following lamination.

The conventional dry-lamination device directly applies dry film photoresist on the substrate without applying an initial water film first. The conventional wet-lamination device and the dual-fluid spraying device of the invention work as stated above (e.g., see Example 1).

In this example, the substrate was formed with 10 parallel bump lines having bumps with 14 μm bump height. The bump lines were perpendicular to the feeding direction of the substrate to the lamination device or dual-fluid spraying device of the invention. The substrate was initially coated with the water film by the wet-lamination device or the dual-fluid spraying device of the invention (the substrate for the dry-lamination device was not coated with the water film). After the coating of the water film, the substrate was laminated with the dry film photoresist and then was exposed and developed. Lastly, the substrate was etched to form 10 parallel conductive lines thereon. The conductive lines were perpendicular to and crossed over the bump lines. Therefore, there were 100 cross-over points on the conductive lines wherein 90 points were checked on the conductive lines to see if the conductive lines were adequately etched without defects. While the conductive line was 75 μm wide and the bump was 75 μm wide, 71 defects out of 90 check points were found on the substrate processed by the conventional dry-lamination device, 5 defects were found on the substrate processed by the conventional wet-lamination device, and no defect was found on the substrate processed by the dual-fluid spraying device of the invention. While the conductive line was 85 μm wide and the bump was 75 μm wide, 46 defects out of 90 check points were found on the substrate processed by the conventional dry-lamination device, 1 defect was found on the substrate processed by the conventional wet-lamination device, and no defect was found on the substrate processed by the dual-fluid spraying device of the invention.

### LIST OF REFERENCE NUMERALS

100 Spraying device
110 Nozzle
110a First nozzle
110b Second nozzle
120 Auxiliary roller
130 Liquid containing roller unit
200 Substrate
300 Spraying device
310 Spraying unit
312a First inlet pipe
312b Second inlet pipe
314 Nozzle

We claim:

1. A spraying device, to be used in an image transfer process, comprising:
at least one nozzle, wherein a fluid is supplied to each nozzle, so that the at least one nozzle sprays the fluid onto a substrate to form a liquid film prior to lamination of a photoresist onto the substrate.

2. The spraying device according to claim 1, wherein the at least one nozzle comprises a plurality of first nozzles and a plurality of second nozzles configured opposite the first nozzles, with a distance between the first nozzles and the second nozzles to allow the substrate to pass between the first nozzles and the second nozzles.

3. The spraying device according to claim 2, wherein a distance between the plurality of first nozzles and the substrate is substantially equal to a distance between the plurality of second nozzles and the substrate.

4. The spraying device according to claim 3, wherein the distance between each of the first nozzles and the substrate and the distance between each of the second nozzles and the substrate are in a range of 10 mm to 200 mm.

5. The spraying device according to claim 2, further comprising an auxiliary roller, disposed on a side of the first and second nozzles where the substrate passes between the plurality of first nozzles and the plurality of second nozzles and suitable for guiding the substrate to pass between the first and second nozzles.

6. The spraying device according to claim 2, further comprising a liquid containing roller unit, disposed on another side of the first and second nozzles where the substrate passes away from the nozzles.

7. The spraying device according to claim 1, wherein the liquid film is a water film.

8. The spraying device according to claim 1, wherein an average particle size of the liquid ejected by each nozzle is in a range of 100 μm to 400 μm.

9. The spraying device according to claim 1, wherein a temperature of the liquid ejected by each nozzle is in a range of 22° C. to 60° C.

10. The spraying device according to claim 1, wherein a pressure for driving the fluid into each nozzle is in a range of 1 kg/cm² to 5 kg/cm².

11. A spraying device, to be used in an image transfer process, comprising:
at least one spraying unit, each comprising a first inlet pipe, a second inlet pipe, and a nozzle connected to the first inlet pipe and the second inlet pipe, wherein a liquid and a gas are guided in the first inlet pipe and the second inlet pipe respectively and then mixed into a plurality of foggy droplets to be ejected by the nozzle, so as to spray the liquid to form a film of the liquid on the substrate prior to lamination of a photoresist onto the substrate.

12. The spraying device according to claim 11, wherein the at least one spraying unit comprises a plurality of first nozzles and a plurality of second nozzles configured opposite the first nozzles, with a distance between the first nozzles and the second nozzles being such as to allow the substrate to pass between the first nozzles and the second nozzles.

13. The spraying device according to claim 12, wherein a distance between the first nozzles and the substrate is equal to a distance between the second nozzles and the substrate.

14. The spraying device according to claim 13, wherein the distance between each of the first nozzles and the substrate and the distance between each of the second nozzles and the substrate are in a range of 10 mm to 200 mm.

15. The spraying device according to claim 12, further comprising an auxiliary roller, disposed on a side of the nozzles where the substrate passes between the plurality of first nozzles and the plurality of second nozzles and suitable for guiding the substrate to pass between the nozzles.

16. The spraying device according to claim 12, further comprising a liquid containing roller unit, disposed on another side of the nozzles where the substrate passes away from the nozzles.

17. The spraying device according to claim 11, wherein the liquid film is a water film.

18. The spraying device according to claim 11, wherein the average particle size of the liquid ejected by each nozzle is in a range of 20 μm to 100 μm.

19. The spraying device according to claim 11, wherein a temperature of the liquid ejected by each nozzle is approximately in a range of room temperature to 60° C.

20. The spraying device according to claim 11, wherein the liquid is driven into the first inlet pipe of each nozzle in a siphon manner.

21. The spraying device according to claim 11, wherein the liquid is driven into the first inlet pipe of each nozzle in a hydraulic manner.

22. The spraying device according to claim 21, wherein a pressure for driving the liquid into the first inlet pipe of each nozzle in the hydraulic manner is in a range of 1 kg/cm² to 5 kg/cm².

23. The spraying device according to claim 11, wherein a pressure for driving the gas into the second inlet pipe of each nozzle is approximately in a range of 0.1 kg/cm² to 5 kg/cm².
